(19) United States
(12) Patent Application Publication
(10) Pub. No.: US 2010/0045446 A1
(43) Pub. Date: Feb. 25, 2010

(54) RFID SYSTEM USING HUMAN BODY COMMUNICATION

(75) Inventors: SEOK BONG HYUN, Daejeon (KR); Sung Weon Kang, Daejeon (KR); Tae Young Kang, Seoul (KR); Tae Wook Kang, Daejeon (KR); Kyung Soo Kim, Daejeon (KR); Sung Eun Kim, Seoul (KR); Jung Bum Kim, Daejeon (KR); Jin Kyung Kim, Daejeon (KR); Hey Jin Myoung, Seoul (KR); Kyung Hwan Park, Daejeon (KR); Hyung II Park, Daejeon (KR); In Gi Lim, Daejeon (KR); Byoung Gun Choi, Daegu (KR); Chang Hee Hyoung, Daejeon (KR); Jung Hwan Hwang, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/408,093

(22) Filed: Mar. 20, 2009

(30) Foreign Application Priority Data
Aug. 22, 2008 (KR) 10-2008-0082352

(51) Int. Cl. H04Q 5/22

(52) U.S. Cl. 340/10.51

(57) ABSTRACT

An a Radio Frequency Identification (RFID) system using human body communication includes a first electrode pad receiving a signal of a reader transmitted through a human body, or outputting an output signal to the human body, a rectifier rectifying the signal of the reader to generate a direct current (DC) voltage, a power manager changing the DC voltage into an operation voltage, a modulator/demodulator demodulating the signal of the reader, or modulating the output signal of the tag to transfer the modulated signal to the first electrode pad, a digital controller performing a read or write operation in response to the signal of the reader demodulated by the modulator/demodulator, and a memory storing identification information of the tag and information according to an operation result of the digital controller.

### CROSS-REFERENCE TO RELATED APPLICATIONS

This application claims the priority of Korean Patent Application No. 2008-82352 filed on Aug. 22, 2008, in the Korean Intellectual Property Office, the disclosure of which is incorporated herein by reference.

### BACKGROUND OF THE INVENTION

1. Field of the Invention

The present invention relates to a Radio Frequency Identification (RFID) system, and more particularly, to an RFID system using human body communication which enables a tag to communicate with a reader using the human body as a transmission medium.

2. Description of the Related Art

In general, human body communication is a communication system that transmits data while a current directly flows between devices attached to the human body through the human body used as a transmission medium. The human body communication uses a baseband signal less than 30 MHz which does not use a carrier, and is used for a high-speed wireless communication from hundreds kps to tens Mbps according to modulation systems.

A Radio Frequency Identification (RFID) technology is a technology that reads out information from a tag or records information in the tag using a Radio Frequency (RF), and is mainly used to identify, trace and manage objects, animals and people to which the tag is attached.

A system using such an RFID technology, i.e., an RFID system has unique identification information, and includes a transponder or a tag attached to objects, animals and people to be identified, a reader which reading out identification information of the tag or writing information in the tag, an object database, and a network.

The RFID system is divided into an inductive coupling scheme and an electromagnetic wave scheme according to wireless access systems. The inductive coupling scheme is a scheme that wirelessly accesses through a coil antenna, and is mainly used for a near distance (within 1 m). The electromagnetic wave scheme is a scheme that wirelessly accesses using a high-frequency antenna, and is mainly used for a medium and long distance.

FIG.1 is a block diagram of a related art RFID system using the inductive coupling scheme.

Referring to FIG. 1, like a transformer, the related art RFID system uses the principle that an inductive current by an alternating current (AC) magnetic field flows between a coil antenna 103 of a tag 100 and a coil antenna 121 of a reader 120 which are very near to each other.

The coil antenna 121 of the reader 120 generates an electromagnetic field which is robust and has a high frequency around it, and a portion of an emitted magnetic field allows an inductive current to flow through the coil antenna 103 of the tag 100 which is slightly separated from the reader 120.

The tag 100 generates an operation voltage from an inductive current, and allows a voltage of the coil antenna 121 of the reader 120 to be changed by varying a tag load, thereby informing the reader 120 of its own information.

However, the coil antenna 121 of the reader 120 and the coil antenna 103 of the tag 100 must be near within tens cm in order for communication between the tag 100 and the reader 120 in inductive coupling scheme.

Therefore, users must bring the reader 120 into contact with an object to which the tag 100 is attached, or users must approach the tag 100 to the reader 120.

FIG. 2 is a block diagram of a related art RFID system using the electromagnetic wave scheme.

In the related art RFID system of FIG. 2, when a reader 220 outputs an electromagnetic wave having a very high power more than 500 mW, a tag 210 receives a portion of the electromagnetic wave through two antennas 210 and 202 to thereby generate an operation voltage necessary for driving a chip. The tag 210 activated by the operation voltage transmits a response signal to the reader 220 in a backscattering scheme.

The related art RFID system using such an electromagnetic scheme can recognize a tag by the propagation characteristics of the electromagnetic wave even at a relatively long distance more than 3 m.

However, when there exists a first tag peripheral to a second tag attached to an object to be identified, information of the first tag is also read out together with information of the second tag, and an error of recognition is caused by propagation intensity which is changed according to environments peripheral to the second tag.

Moreover, an unauthenticated reader reads out information of a tag so that the related art RFID system is relatively vulnerable to security.

### SUMMARY OF THE INVENTION

An aspect of the present invention provides a Radio Frequency Identification (RFID) system using human body communication, which is capable of enhancing convenience, reliability and security for use.

Another aspect of the present invention provides an RFID system using human body communication, which can transmit data even in a related art communication system as well as a human body communication system.

Another aspect of the present invention provides an RFID system using human body communication, which enables a tag to include a separate sensor and to provide the sensing information of the sensor to a reader.

According to an aspect of the present invention, there is provided a tag of a Radio Frequency Identification (RFID) system using human body communication, the tag including: a first electrode pad receiving a signal of a reader transmitted through a human body, or outputting an output signal to the human body; a rectifier rectifying the signal of the reader to generate a direct current (DC) voltage; a power manager changing the DC voltage into an operation voltage; a modulator/demodulator demodulating the signal of the reader, or modulating the output signal of the tag to transfer the modulated signal to the first electrode pad; a digital controller performing a read or write operation in response to the signal of the reader demodulated by the modulator/demodulator; and a memory storing identification information of the tag and information according to an operation result of the digital controller.

The tag may further include: a second electrode pad; a coil connected between the first electrode pad and the second electrode pad; and a mode selector connecting the rectifier to the second electrode pad when the tag operates in a first operation mode, and disconnecting the rectifier from the second electrode pad when the tag operates in a second operation mode. The first operation mode may be a mode where the tag operates in an inductive coupling scheme or an electromagnetic wave scheme, and the second operation mode may be a mode where the tag operates in a human body communication system.

The tag may further include an impedance matcher disposed in a front portion of the rectifier to vary an input impedance value of the tag. The impedance matcher may include: a plurality of capacitors connected to the first electrode pad in parallel; a plurality of switches connected between the capacitors and the second electrode pad respectively; and a variable capacitor connected between the first and second electrode pads.

The digital controller may further include a function that determines the operation mode of the tag and input impedance value.

The tag may further include: a sensor; a interface interfacing a signal transceived between the sensor and the digital controller; and a battery charging a voltage according to a signal input through the first electrode pad to generate an operation voltage, wherein the digital controller may further include a function that stores sensing information of the sensor in the memory or provides the sensing information of the sensor to the reader.

According to another aspect of the present invention, there is provided an RFID system using human body communication, including: a tag receiving an operation voltage from a signal transmitted through a human body to operate, and outputting a response signal to the human body; and a reader generating a signal having an energy source or a command to be transmitted to the tag, outputting the generated signal to the human body, and receiving the response signal of the tag transmitted through the human body to read the received response signal.

The tag may include: a first electrode pad receiving a signal of the reader transmitted through a human body, or outputting the output signal of the tag to the human body; a rectifier rectifying the signal of the reader to generate a direct current (DC) voltage; a power manager changing the DC voltage into an operation voltage; a modulator/demodulator demodulating the signal of the reader, or modulating the output signal of the tag to transfer the modulated signal to the first electrode pad; a digital controller performing a read or write operation in response to the signal of the reader demodulated by the modulator/demodulator; and a memory storing identification information of the tag and information according to an operation result of the digital controller.

The tag may further include: a second electrode pad; a coil connected between the first electrode pad and the second electrode pad; a mode selector connecting the rectifier to the second electrode pad when the tag operates in a first operation mode, and disconnecting the rectifier from the second electrode pad when the tag operates in a second operation mode; and an impedance matcher disposed in a front portion of the rectifier to vary an input impedance value of the tag. The first operation mode may be a mode where the tag operates in an inductive coupling scheme or an electromagnetic wave scheme, and the second operation mode may be a mode where the tag operates in a human body communication system.

The tag may further include: a sensor; a interface interfacing a signal transceived between the sensor and the digital controller; and a battery charging a voltage according to a signal input through the first electrode pad to generate an operation voltage, wherein the digital controller may further include a function that stores sensing information of the sensor in the memory or provides the sensing information of the sensor to the reader.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a related art RFID system using an inductive coupling scheme;

FIG. 2 is a block diagram of a related art RFID system using an electromagnetic wave scheme;

FIG. 3 is an exemplary diagram for describing an RFID system using human body communication according to an embodiment of the present invention;

FIG. 4 is a block diagram of a tag according to an embodiment of the present invention;

FIG. 5 is a block diagram of a tag according to another embodiment of the present invention;

FIG. 6 is a circuit diagram of a mode selector and impedance matcher shown in FIG. 5;

FIGS. 7A to 7D are circuit diagrams of a mode selector and impedance matcher shown in FIG. 5; and

FIG. 8 is a block diagram of a tag according to another embodiment of the present invention.

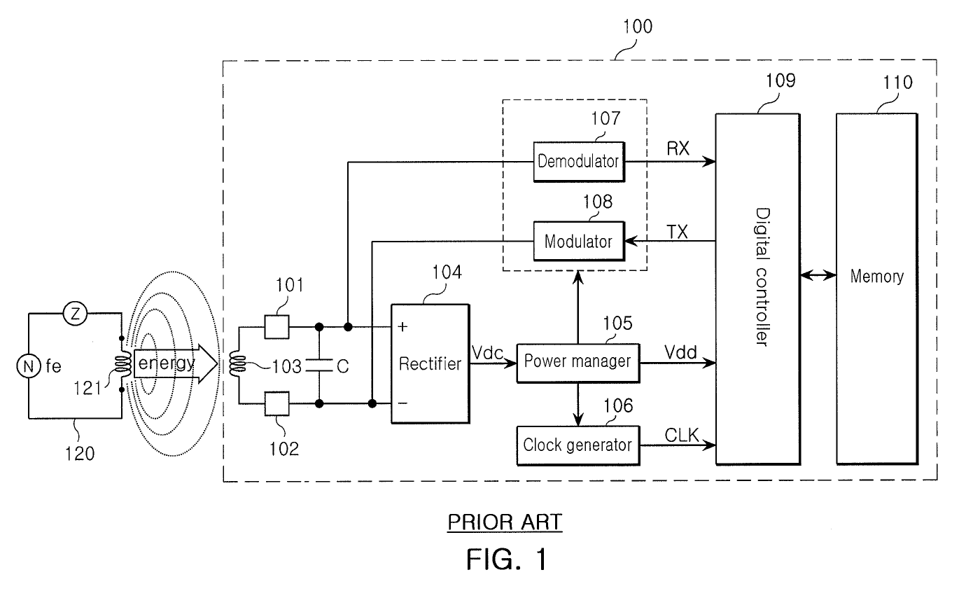

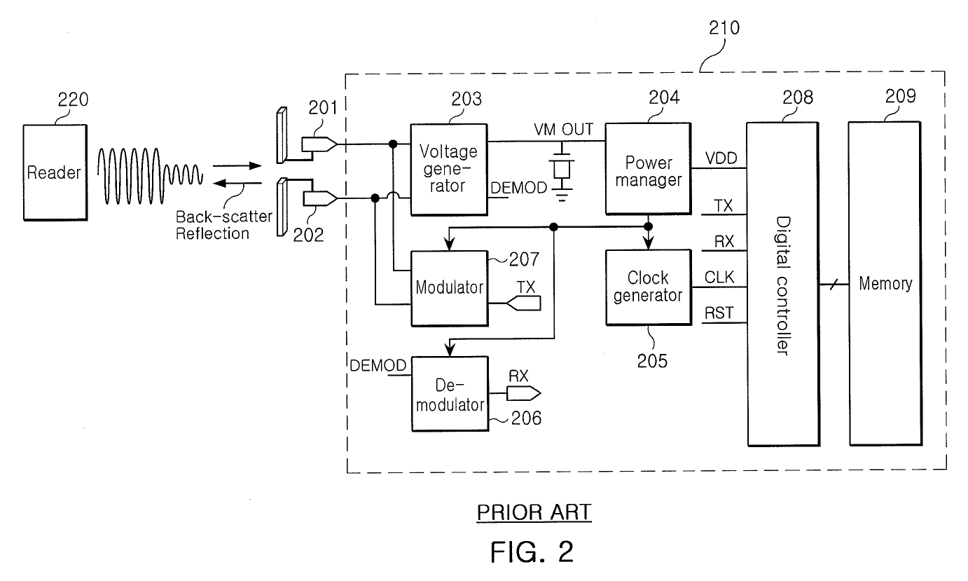

### DETAILED DESCRIPTION OF THE PREFERRED EMBODIMENT

Exemplary embodiments of the present invention those skilled in the art can easily embody will now be described in detail with reference to the accompanying drawings. However, detailed descriptions related to well-known functions or configurations will be ruled out in order not to unnecessarily obscure subject matters of the present invention.

Moreover, like reference numerals refer to like elements throughout.

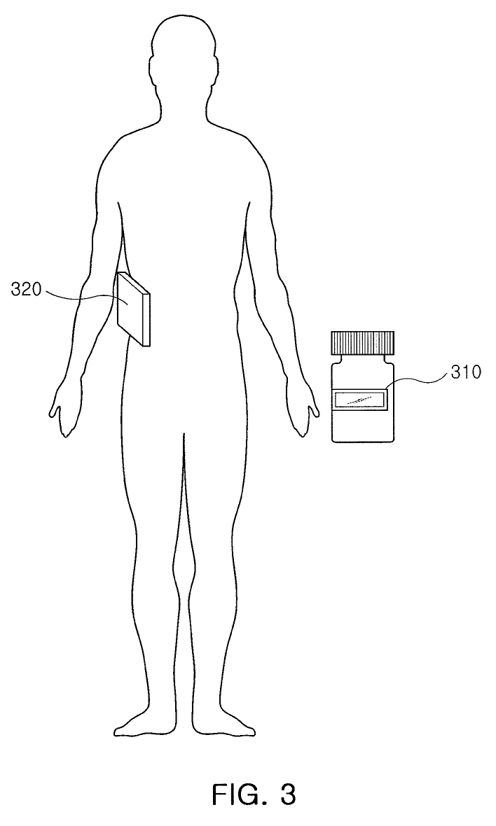

FIG. 3 is an exemplary diagram for describing a Radio Frequency Identification (RFID) system using human body communication according to an embodiment of the present invention.

Referring to FIG. 3, the RFID system based on human body communication includes a tag 310 attached to an object (or an animal and a person), and a reader 320 attached to the human body, wherein the tag 310 and the reader 320 transmit and receive a signal using the human body as a transmission medium.

The tag 310 includes an electrode pad which is near (or contact) the human body. When the human body to which the reader 320 is attached approaches the electrode pad, the signal transmission path between the tag 310 and the reader 320 is established through the human body.

When the reader 320 outputs a transmission signal to the human body in a capacitive coupling scheme, the tag 310 receives the transmission signal in the capacitive coupling scheme, generates an operation voltage, and analyzes the transmission signal.

When the reader 320 requests a read operation as an analysis result of the transmission signal, the tag 310 reads its own information (for example, identification information of the tag 310) and transfers the read information to the reader 320 trough the human body. On the other hand, when the reader 320 requests a write operation as the analysis result of the transmission signal, information transmitted from the reader 320 is stored in a memory of the tag 310.

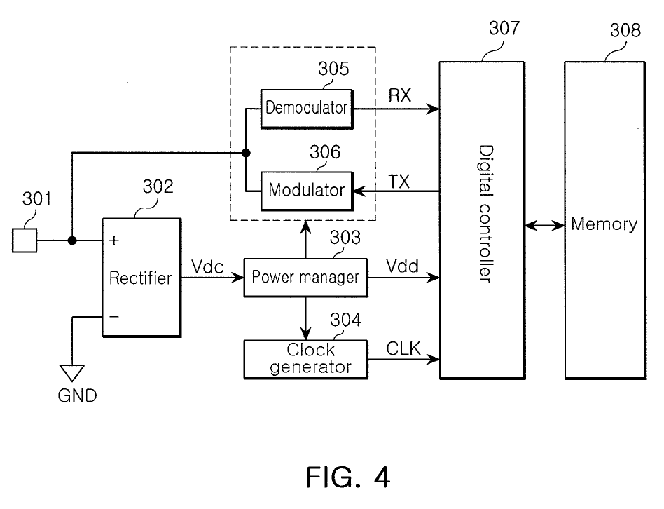

Since a related art tag using a coil or an antenna cannot be used as-is for human body communication of the present invention, a structure of a tag is changed as illustrated in FIG. 4.

FIG. 4 is a block diagram of the tag according to an embodiment of the present invention.

Referring to FIG. 4, the tag 310 of the present invention includes a first electrode pad 301, a rectifier 302, a power manager 303, a clock generator 304, a demodulator 305, a modulator 306, a digital controller 307, and a memory 308.

The first electrode pad 301 is disposed in a front portion of the tag 310 in order for the human body to easily approach (or contact). When the human body is near, the first electrode pad 301 receives a signal of the reader 320 transmitted through the human body, or outputs a response signal of the tag 310 corresponding to the signal of the reader 320 to the human body.

In an embodiment of the present invention, the reason that the tag 310 includes only one electrode pad 301 is for enabling to transceive a signal in the capacitive coupling scheme by forbidding the same voltage to be applied to both input terminals of the rectifier 302.

The rectifier 302 includes an input terminal+connected to the first electrode pad 301 and an input terminal−connected to a ground voltage terminal GND. The rectifier 302 rectifies a signal of the reader 320 input to the input terminal+, i.e., a weak AC signal to generate a direct current (DC) voltage Vdc.

The power manager 303 includes a bias generating circuit, a regulator and the like, and changes the DC voltage Vdc into an operation voltage Vdd necessary for driving a chip through the bias generating circuit and the regulator.

The clock generator 304 receives the operation voltage Vdd to thereby be activated. The clock generator 304 generates a clock signal CLK and provides the generated clock signal CLK to the digital controller 307.

The demodulator 305 is connected to the first electrode pad 301. The demodulator 305 demodulates a signal of the reader 320 input through the first electrode pad 301 to thereby change the signal into a signal capable of being recognized by the digital controller 307, and provides the changed signal to the digital controller 307.

The modulator 306 modulates a signal output from the digital controller 307 in the backscattering scheme and outputs the modulated signal to the first electrode pad 301.

The digital controller 307 analyzes the signal demodulated by the demodulator 305, i.e., the signal of the reader 320 to read a command of the reader 320, and performs a read operation or a write operation to the memory 280.

If a read command is transmitted from the reader 320, the digital controller 307 reads out information recorded in the memory 280 (for example, the identification information of the tag 310) and transfers the read information to the modulator 306. On the other hand, if a write command on specific information is transmitted, the digital controller 307 stores the specific information in an empty memory area of the memory 280.

The memory 308 stores the identification information of the tag 310. Moreover, when necessary, the memory 308 may additionally store information transmitted from the reader 320.

The memory 308 may be implemented with a nonvolatile memory capable of being integrated and small size in order to minimize the layout of the tag 310. Examples of the nonvolatile memory include a Phase-Change Memory (PCM), a Ferroelectric Random Access Memory (FRAM), a Magnetoresistive Random Access Memory (MRAM) and the like.

The tag 310 operates only in a human body communication system. However, when necessary, an operation mode may be multiple by changing a structure of the input terminals of the tag 310. That is, the tag 310 may operate in the inductive coupling scheme or the electromagnetic wave scheme, in addition to the human body communication system.

Moreover, the impedance matching between the human body and the tag 310 may be performed in order to minimize influences according to the operation environments of the tag 310 and the body conditions of the human body near the tag 310.

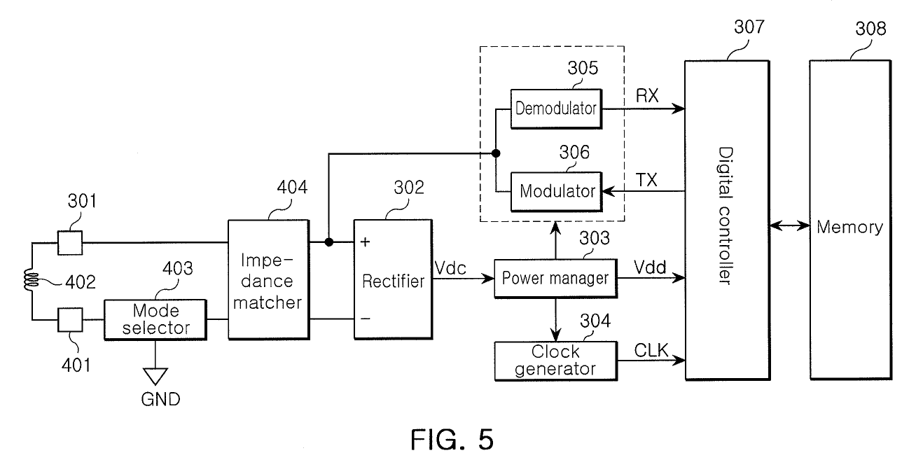

FIG. 5 is a block diagram of a tag according to another embodiment of the present invention. The tag of FIG. 5 can further perform multiple modes and an impedance matching operation.

Referring to FIG. 5, the tag according to another embodiment of the present invention includes the first electrode pad 301, the rectifier 302, the power manager 303, the clock generator 304, the demodulator 305, the modulator 306, the digital controller 307, and the memory 308, like FIG. 4. Furthermore, the tag according to another embodiment of the present invention further includes a second electrode pad 401, a coil 402, a mode selector 403, and an impedance matcher 404.

The coil 402 may be connected between the first electrode pad 301 and the second electrode pad 401 to function as an antenna, like the related art RFID system using the inductive coupling scheme.

The mode selector 403 is disposed between the second electrode pad 401 and the input terminal—of the rectifier 210. Therefore, when the tag 310 operates in the human body communication system, the mode selector 403 disconnects the rectifier 210 from the second electrode pad 401. When the tag 310 operates in the inductive coupling scheme, the mode selector 403 connects the rectifier 210 to the second electrode pad 401.

As described above, when the tag 310 operates in the human body communication system, a signal is transceived through one electrode pad 301 in the capacitive coupling scheme. However, when the tag 310 operates in the inductive coupling scheme, a signal is transceived through the coil connected between the first and second electrode pads 301 and 401 in the inductive coupling scheme.

The impedance matcher 404 is connected between the first and second electrode pads 301 and 401 to actively change an input impedance value of the tag 310.

In addition, to support operations of the mode selector 403 and the impedance matcher 404, the digital controller 307 of FIG. 5 further includes a function that controls the mode selector 403 according to an operation mode of the tag 310, and a function that calculates an input impedance value where an attenuation of a signal is minimized and controls an impedance value of the impedance matcher 404 according to the calculated impedance value.

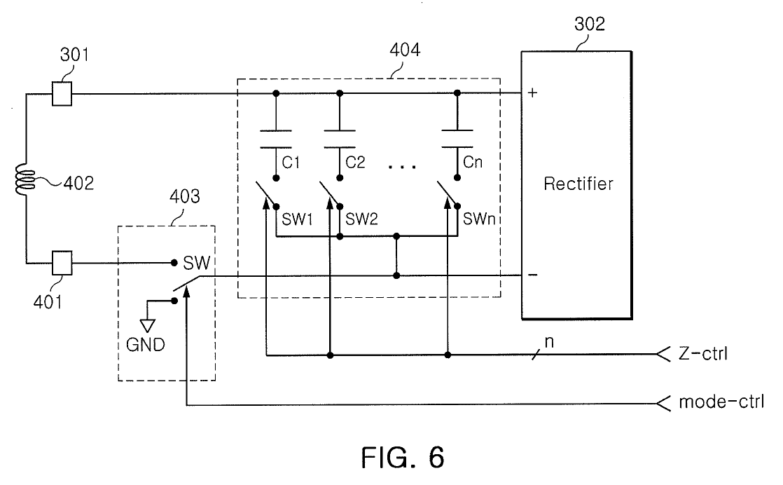

FIG. 6 is a circuit diagram of the mode selector 403 and impedance matcher 404 of FIG. 5.

Referring to FIG. 6, the mode selector 403 includes a switch SW disposed between the second electrode pad 401 and the input terminal—of the rectifier 302.

The switch SW may be implemented with a transmission gate circuit including a Metal Oxide Semiconductor field effect transistor (MOS) device or a Micro-Electro-Mechanical System (MEMS) switch device, and connects the input terminal—of the rectifier 302 to the second electrode pad 401 or the ground voltage terminal GND according to a mode control signal mode-ctrl. That is, the switch SW connects or disconnects the rectifier 302 and the second electrode pad 401 according to the mode control signal mode-ctrl.

The mode control signal mode-ctrl is a signal for informing a current operation mode of the tag 310, and is generated and provided by the digital controller 307.

The impedance matcher 404 is implemented with a plurality of capacitors C1 to Cn which are connected to the first electrode pad 301 in parallel and a plurality of switches SW1 to SWn which are respectively connected between the capacitors C1 to Cn and the second electrode pad 401. Furthermore, the impedance matcher 404 varies the number of switches which are switched on/off according to an impedance control signal Z-ctrl, thereby varying the input impedance value.

At this point, the impedance control signal Z-ctrl is an n-bit signal for changing the input impedance value of the tag 310. Such an n-bit signal corresponds to a plurality of switches SW1 to SWn respectively, and is generated and provided by the digital controller 307.

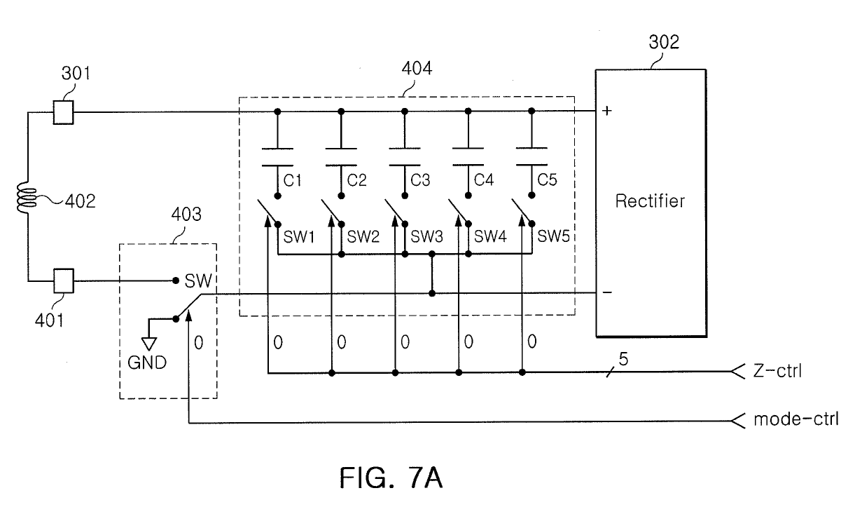

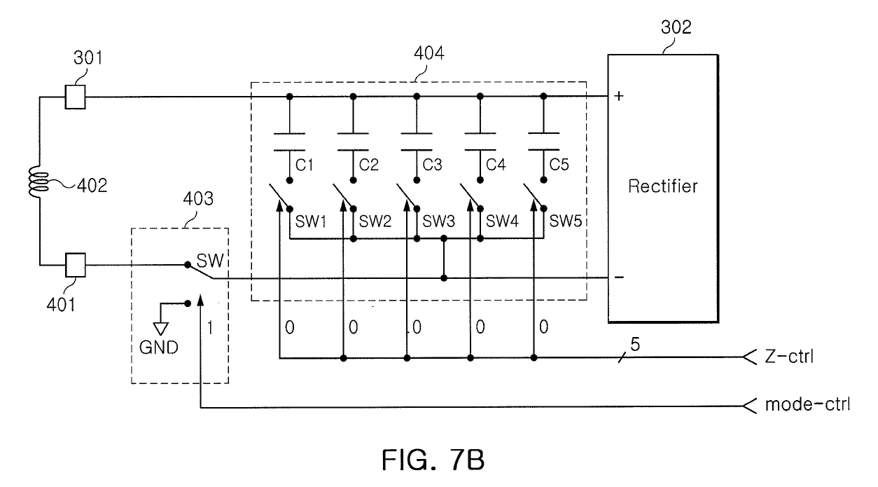

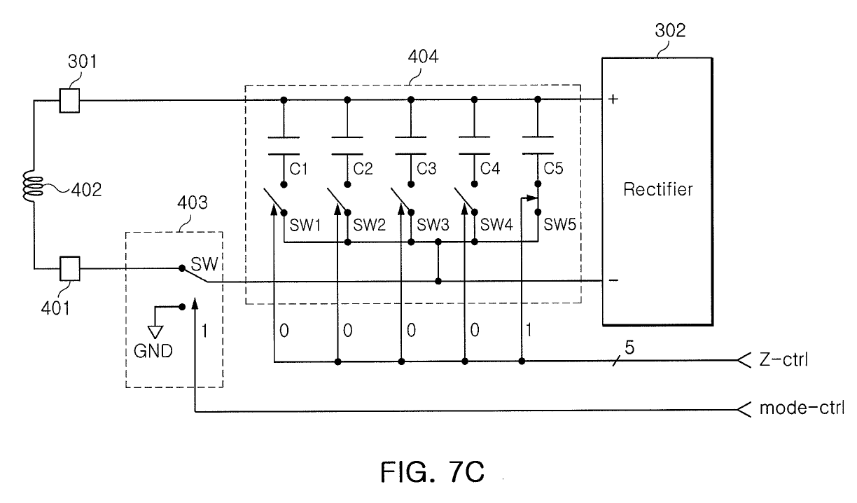

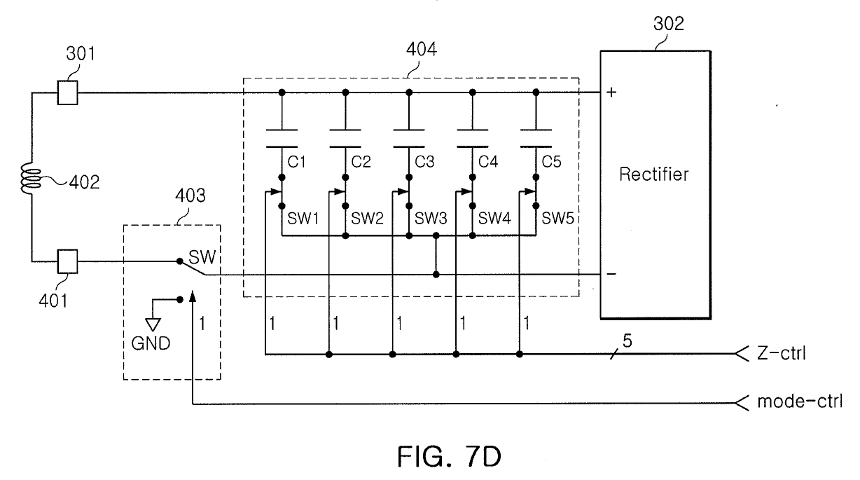

Hereinafter, operations of the mode selector 403 and the impedance matcher 404 will be described with reference to FIGS. 7A to 7D.

As illustrated in FIG. 7A, when the tag 310 operates in the human body communication system, the mode selector 403 receives the mode control signal mode-ctrl of a first value (for example, a voltage of a 0 or low level) from the digital controller 307.

At this point, a switch SW of the mode selector 403 is switched off to disconnect the input terminal—of the rectifier 302 from the second electrode pad 401. Then, as illustrated in FIG. 4, the rectifier 302 generates a DC voltage using only an AC signal input through the first electrode pad 301. That is, the rectifier 302 generates the DC voltage using a displacement current generated according to the capacitive coupling of the first electrode pad 301.

On the other hand, as illustrated in FIG. 7B, when the tag 310 operates in the inductive coupling scheme, the mode selector 403 receives the mode control signal mode-ctrl of a second value (for example, a voltage of a 1 or high level) from the digital controller 307.

Subsequently, the switch SW of the mode selector 403 is switched on to connect the input terminal—of the rectifier 302 to the second electrode pad 401, and the rectifier 302 generates a DC voltage using a displacement current generated according to the inductive coupling of the coil 402.

Moreover, the impedance matcher 404 varies the input impedance value according to the impedance control signal Z-ctrl provided from the digital controller 307.

As illustrated in FIGS. 7C and 7D, the number of the capacitors, which are connected between the first and second electrode pads 301 and 401 in parallel, varies according to a control value of the impedance control signal Z-ctrl.

The number of the capacitors, which are connected between the first and second electrode pads 301 and 401 in parallel, is reduced as the control value of the impedance control signal Z-ctrl decreases, and thus the input impedance value of the tag 310 decreases.

On the other hand, the number of the capacitors, which are connected between the first and second electrode pads 301 and 401 in parallel, increases as the control value of the impedance control signal Z-ctrl increases, and thus the input impedance value of the tag 310 increases.

That is, the impedance matcher 404 varies the number of the capacitors to be connected between the first and second electrode pads 301 and 401 in parallel, according to the control value of the impedance control signal Z-ctrl, and thus controls the input impedance value of the tag 310.

In the above-described embodiments, the impedance matcher 404 is implemented with a capacitor array and a switch array. However, it is apparent that the impedance matcher 404 may be implemented with one variable capacitor such as a varactor when necessary.

In this case, the impedance control signal Z-ctrl must be replaced with a signal, an amount of current or voltage level of which varies with a control value, instead of the n-bit signal.

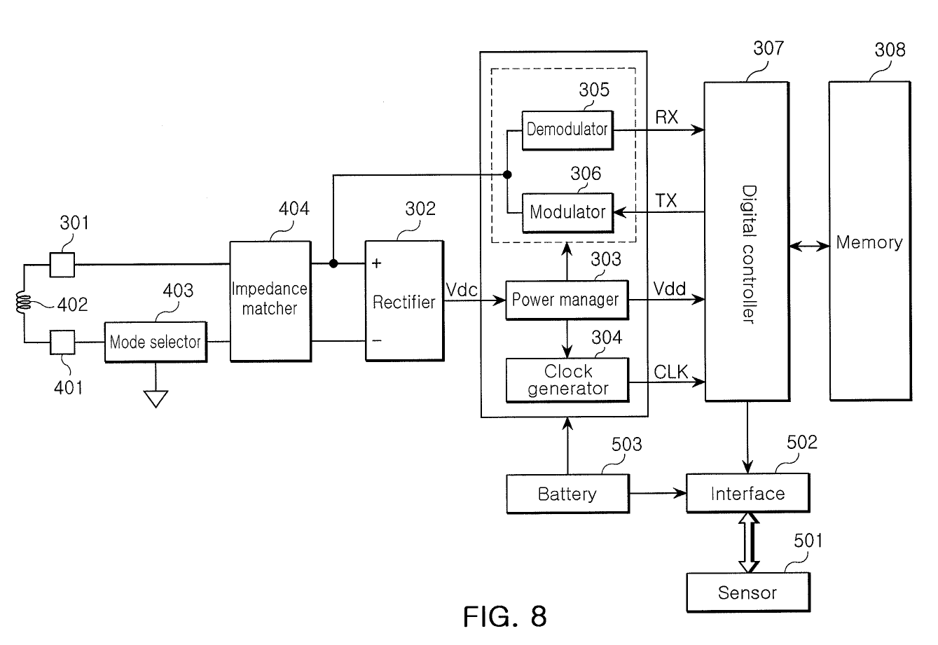

FIG. 8 is a block diagram of a tag according to another embodiment of the present invention. The tag of FIG. 8 may further include a sensor.

The tag of FIG. 8 further includes a sensor 501, and an interface 502 interfacing a signal transceived between the sensor 501 and the digital controller 307, other than the elements of FIG. 4 or FIG. 5.

The digital controller 307 interworks with the sensor 501 so that it stores the sensing information of the sensor 501 in the memory 308 or provides the sensing information of the sensor 501 to the reader 320.

Moreover, the tag of FIG. 8 may further include a battery 503 performing a charge/discharge operation using a signal transmitted from the reader 310. This is because a large amount of power is temporarily required according to a kind of the sensor 501 upon drive of the sensor 501.

The RFID system using human body communication according to the embodiments of the present invention transmits data using the human body as a transmission medium, thereby considerably reducing power consumption of the reader and the tag. The RFID system using human body communication identifies information of the tag and transmits data only by approaching or contacting a portion of the human body, without user's approaching the reader or the tag, thereby enhancing convenience for use.

In the RFID system using human body communication according to embodiments of the present invention, since the transmission medium of a signal is limited to the human body, reliability and security is enhanced and an error rate of recognition is reduced. Consequently, an application range of the RFID system can be expanded to a medical industry and a defense industry requiring high reliability.

The RFID system using human body communication according to embodiments of the present invention provides multiple modes, thereby enabling to transmit data between a reader and a tag using both the human body communication system and the related art communication system. In addition, the RFID system using human body communication enables a tag to include a separate sensor and to provide the sensing information of the sensor to a reader, thereby maximizing the use of the RFID system.

While the present invention has been shown and described in connection with the exemplary embodiments, it will be apparent to those skilled in the art that modifications and variations can be made without departing from the spirit and scope of the invention as defined by the appended claims.

What is claimed is:

1. A tag of a Radio Frequency Identification (RFID) system using human body communication, the tag comprising:
a first electrode pad receiving a signal of a reader transmitted through a human body, or outputting an output signal to the human body;
a rectifier rectifying the signal of the reader to generate a direct current (DC) voltage;
a power manager changing the DC voltage into an operation voltage;
a modulator/demodulator demodulating the signal of the reader, or modulating the output signal of the tag to transfer the modulated signal to the first electrode pad;
a digital controller performing a read or write operation in response to the signal of the reader demodulated by the modulator/demodulator; and
a memory storing identification information of the tag and information according to an operation result of the digital controller.

2. The tag of claim 1, further comprising:
a second electrode pad;
a coil connected between the first electrode pad and the second electrode pad; and
a mode selector connecting the rectifier to the second electrode pad when the tag operates in a first operation mode, and disconnecting the rectifier from the second electrode pad when the tag operates in a second operation mode.

3. The tag of claim 2, wherein the first operation mode is a mode where the tag operates in an inductive coupling scheme or an electromagnetic wave scheme, and the second operation mode is a mode where the tag operates in a human body communication system.

4. The tag of claim 2, further comprising an impedance matcher disposed in a front portion of the rectifier to vary an input impedance value of the tag.

5. The tag of claim 4, wherein the impedance matcher comprises:
a plurality of capacitors connected to the first electrode pad in parallel; and
a plurality of switches connected between the capacitors and the second electrode pad respectively.

6. The tag of claim 4, wherein the impedance matcher comprises a variable capacitor connected between the first and second electrode pads.

7. The tag of claim 4, wherein the digital controller further comprises a function that determines the operation mode of the tag and input impedance value.

8. The tag of claim 1, further comprising:
a sensor; and
a interface interfacing a signal transceived between the sensor and the digital controller,
wherein the digital controller further comprises a function that stores sensing information of the sensor in the memory or provides the sensing information of the sensor to the reader.

9. The tag of claim 8, further comprising a battery charging a voltage according to a signal input through the first electrode pad to generate an operation voltage.

10. A Radio Frequency Identification (RFID) system using human body communication, comprising:
a tag receiving an operation voltage from a signal transmitted through a human body to operate, and outputting a response signal to the human body; and
a reader generating a signal having an energy source or a command to be transmitted to the tag, outputting the generated signal to the human body, and receiving the response signal of the tag transmitted through the human body to read the received response signal.

11. The RFID system of claim 10, wherein the tag comprises:
a first electrode pad receiving a signal of the reader transmitted through a human body, or outputting the output signal of the tag to the human body;
a rectifier rectifying the signal of the reader to generate a direct current (DC) voltage;
a power manager changing the DC voltage into an operation voltage;
a modulator/demodulator demodulating the signal of the reader, or modulating the output signal of the tag to transfer the modulated signal to the first electrode pad;
a digital controller performing a read or write operation in response to the signal of the reader demodulated by the modulator/demodulator; and
a memory storing identification information of the tag and information according to an operation result of the digital controller.

12. The RFID system of claim 11, wherein the tag further comprises:
a second electrode pad;
a coil connected between the first electrode pad and the second electrode pad;
a mode selector connecting the rectifier to the second electrode pad when the tag operates in a first operation mode, and disconnecting the rectifier from the second electrode pad when the tag operates in a second operation mode; and
an impedance matcher disposed in a front portion of the rectifier to vary an input impedance value of the tag.

13. The RFID system of claim 12, wherein the first operation mode is a mode where the tag operates in an inductive coupling scheme or an electromagnetic wave scheme, and the second operation mode is a mode where the tag operates in a human body communication system.

14. The RFID system of claim 11, wherein the tag further comprises:
a sensor;
a interface interfacing a signal transceived between the sensor and the digital controller; and
a battery charging a voltage according to a signal input through the first electrode pad to generate an operation voltage,
wherein the digital controller further comprises a function that stores sensing information of the sensor in the memory or provides the sensing information of the sensor to the reader.
